(19) United States
(12) Patent Application Publication
(10) Pub. No.: US 2025/0082537 A1
(43) Pub. Date: Mar. 13, 2025

(54) Multipurpose Ergonomic Massage Tool With Shallow Entry, Dilation And Clitoral Stimulation

(71) Applicant: Twenty Three Ventures Inc, Brooklyn, NY (US)

(72) Inventors: Emily Sauer, Brooklyn, NY (US); Nienke Helder, Amsterdam (NL)

(21) Appl. No.: 18/885,114

(22) Filed: Sep. 13, 2024

Related U.S. Application Data
(60) Provisional application No. 63/538,282, filed on Sep. 13, 2023.

(51) Int. Cl. A61H 19/00

(52) U.S. Cl. CPC A61H 19/34; A61H 19/40; A61H 2201/0107; A61H 2201/0153; A61H 2201/5097; A61H 2205/087

(57) ABSTRACT

A massaging device has a vibration mechanism, housing, controller, and narrow, broad and clitoral members. The broad member can be used as a handgrip in various orientations to control the stimulated location and level of stimulation. The narrow member has a conical or pyramid shape with cross sections increasing from the tip to the base, permitting gradual insertion. The device includes a controller enabling a user to turn on and off the vibration mechanism, and to change the vibration pattern and intensity. The relative position of the broad, clitoral and narrow members enables a user to exercise precise and accurate control of the stimulated location and level of stimulation by displacing the device in different planes. In another embodiment, the device has a clitoral vibration motor with variable intensity patterns and a controller that allows a user to manipulate both the vaginal and clitoral vibration mechanisms without moving the device.

### CROSS-REFERENCE TO RELATED APPLICATIONS

This application claims the benefit of U.S. Provisional Patent Application 63/538,282, filed Sep. 13, 2023, entitled Dual Stimulation Massaging Device With Shallow Entry, which is hereby incorporated by reference in its entirety.

### BACKGROUND OF THE INVENTION

The present invention is related to a multipurpose ergonomic massaging device based on anatomical and evidence based design to facilitate improvement of pelvic floor muscle function, facilitate treatment of vaginal entry pain, and encourage a positive mental health experience with penetration.

A large portion of women will experience pain during sex. Often referred to as entry pain, discomfort at the vagina entrance during or after penetration often may be caused by an overactive pelvic floor. This issue is often untreated or overlooked due to insufficient at-home treatment options, social stigmas, and normalization of pain, and may lead to anxiety and avoidance of intimacy. Historically, genital pain has been studied through a biomedical lens, focusing on physical markers like inflammation, infections, and genetic factors. However, fear of pain has emerged as a significant contributor, inducing hypervigilance and increasing pain perception.

Vaginal dilators, also referred to as “trainers” may be used to help reduce or overcome entry pain. Standard rigid dilators come in sets with a starting diameter of a few millimeters that increases with each dilator in the set. The user must insert each dilator from the set and then remove to insert the next size up. The present invention eliminates the discomfort of having to insert and remove a sequence of rigid dilators.

Sexual aid massagers may also be used to help with entry pain. While such devices are well known, their health utility has not been subject to systematic research (outside for improvement of sexual experience). Recently it has been recognized that vibrating massagers may be an accepted modality to improve pelvic floor muscle function, facilitate treatment of vulvar pain, and enhance a woman's sexual experience. (A. Dubinskaya, et al., Is it time for doctors to Rx vibrators? A systematic review of pelvic floor outcomes, Sexual Medicine Reviews, Vol. 11, Issue 1, January 2023, pp. 15-22, https://doi.org/10.1093/sxmrev/qeac008). Vibration appears to increase blood flow to the clitoris and muscles and brings more oxygen to the muscles, helping them relax. Varied pressures and massage modalities may provide individualization, and precise massage and/or vibration application with appropriate intensity may have health benefits. For example, internal massage with optional vibration could be helpful in addition to (or simultaneous with) clitoral massage with optional vibration, as some layers of the pelvic floor muscle group can only be addressed internally. It is also known that adherence to currently available pelvic pain devices is problematic, therefore the incorporation of vibration and arousal into therapeutic exercises proves to be a motivating factor to continue treatment. In addition, the combination of perennial massage for pleasure was also well documented.

The present invention aims to provide devices with a novel approach involving shallow insertion in the vagina of a tapered non-phallic design allowing for gradual dilation without inserting and removing multiple dilators, simultaneous massage of the clitoris and perineum or vagina, various massage modes including vibration.

### SUMMARY OF THE INVENTION

In an embodiment of the invention, an anatomically based, ergonomic, multipurpose massaging device comprises a controller comprising a user control, a vaginal vibrating mechanism, a clitoral vibrating mechanism, a body comprising a broad member and a clitoral stimulation surface, a narrow member comprising a narrow member base and a narrow member tip, and a narrow member length. The body and the narrow member are connected to each other in a fixed relative position to each other. The clitoral stimulation surface forms a clitoral stimulation angle with the narrow member. The vaginal vibrating mechanism is positioned proximate to the narrow tip. The clitoral vibrating mechanism is positioned proximate to the clitoral stimulation surface. The controller is configured to enable a user to utilize the user control to turn on one or more of the vaginal vibrating mechanism and the clitoral vibrating mechanism. The narrow member is configured to allow a shallow insertion in a vagina having a vaginal opening, an introitus, and a vaginal vault. The shallow insertion is an insertion of the narrow tip past the introitus without reaching the vaginal vault. The narrow member length is longer than the introitus and is shorter than the distance between the vaginal opening and the vaginal vault. The fixed relative position is configured to enable the clitoral stimulation surface to rest against the vagina and to prevent the user from inserting the narrow member tip deeper than the narrow member length. The device is configured to enable the user to simultaneously stimulate the clitoris and to insert the narrow member in the vagina. The fixed relative position enables the user to position the clitoral stimulation surface on the clitoris while inserting the narrow member in the vagina. The clitoral stimulation surface has a clitoral stimulation surface length longer than the distance between the vagina and the clitoris.

In another embodiment of the present invention, the device is further configured to enable the user to simultaneously stimulate the clitoris and the external perineum. The fixed relative position enables the user to position the clitoral stimulation surface on the clitoris while the narrow tip is positioned on the perineum. An external stimulation span between a distal edge of the clitoral stimulation surface and the narrow tip is longer than the distance between the perineum and the clitoris. The distal edge connects the clitoral surface and a broad member surface farthest from the narrow member base.

In yet another embodiment of the present invention, the narrow member comprises oval cross sections with diameters that increase from the narrow tip to the narrow member base to enable the user to gradually dilate the vagina by inserting the narrow member in the vagina.

In another embodiment of the present invention, the broad member comprises a finger groove configured to: provide tactile indication to the user of finger positions; allow the user to guide the device in a plurality of orientations by placing a finger in the groove; and, enable the user to apply varied pressure on the narrow tip and clitoral stimulation surface by repositioning the finger in the groove.

In yet another embodiment of the present invention, the body and the narrow member form an ergonomic triangle by the external stimulation span, the broad member surface, and a narrow tip broad tip span. The device is configured to enable the user to ergonomically apply pressure with the narrow member by utilizing the body as a handgrip. The broad member surface is curved to fit in a palm enabling the user to securely hold the device and to apply pressure on the broad member surface without wrist bending. The broad member surface and the narrow member form a pressure transfer angle configured to transfer the pressure applied on the broad member surface through the narrow member to the narrow tip.

In another embodiment of the present invention, the device further comprises a casing. The casing comprises the vaginal vibrating mechanism, the clitoral vibrating mechanism, and a power source being one or both of a battery and power interface. The casing rigidly connects the body and the narrow member base and maintains the body and the narrow member base at a fixed relative position. The power interface is selected from a wired electrical connector and a wireless charging receiver.

In yet another embodiment of the present invention, the vaginal vibrating mechanism and clitoral vibrating mechanism are configured to vibrate at frequencies ranging from 100 Hz to 250 Hz.

In another embodiment of the present invention, the diameters increase from the narrow tip to the narrow member base at a rate ranging from 7.5 mm to 15 mm of diameter increase for 10 mm drop along the narrow member length. The diameters comprise a base diameter no larger than 40 mm. The narrow member length is in the range of 25 mm to 75 mm. The external stimulation span is in the range from approximately 30 mm to 90 mm. The clitoral stimulation surface length is no less than 20 mm and no greater than 72 mm.

In yet another embodiment of the present invention, the narrow member length is in the range from approximately 45 mm to 55 mm.

In another embodiment of the present invention the device further comprises a first outer housing. The casing is positioned inside the first outer housing. The first outer housing and the casing form the narrow member and the body.

In yet another embodiment of the present invention, the device further comprises a second outer housing. The casing and the first outer housing are configured to enable the casing to be removably positioned in the first outer housing. The casing and the second outer housing are configured to enable the casing to be removably positioned in the second outer housing. The first outer housing and the casing form a first narrow member having a first narrow member length. The second outer housing and the casing form a second narrow member having a second narrow member length. The first narrow member length is different from the second narrow member length.

### BRIEF DESCRIPTION OF DRAWINGS

The advantages and features of the present invention will be better understood as the following description is read in conjunction with the accompanying drawings, wherein:

FIG. 1 is an isometric view of an embodiment of the present invention.

FIG. 2 is an illustration of a portion of the pelvic area with an embodiment of the present invention.

FIG. 3 is an isometric view of an embodiment of the present invention.

FIG. 4 illustrates an exemplary use of an embodiment of the present invention.

FIG. 5 illustrates an exemplary use of an embodiment of the present invention.

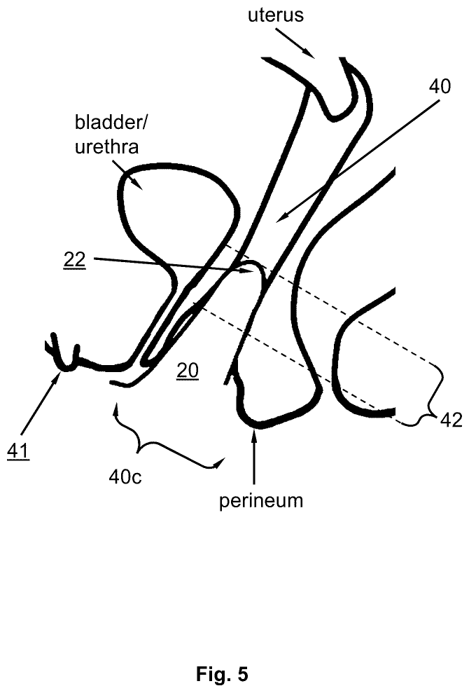

FIG. 6 illustrates a cross-section of an embodiment of the present invention.

FIG. 7 illustrates exemplary uses of an embodiment of the present invention.

FIG. 8 illustrates an embodiment of the present invention.

FIG. 9 illustrates an embodiment of the present invention.

FIG. 10 illustrates an embodiment of the present invention.

### DETAILED DESCRIPTION OF THE INVENTION

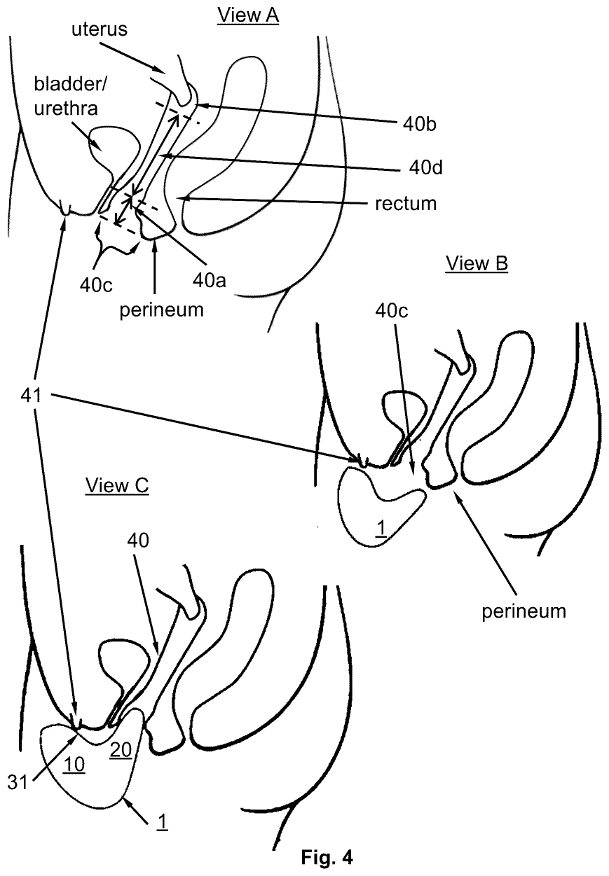

Embodiments of the present invention are directed to an evidence-and anatomically-based design for multiuse, ergonomic, massaging device 1 that can be used to help relax pelvic floor muscles, decrease pain, and encourage continued therapeutic use by incorporating arousal features. Device 1 comprises three versatile massage portions (or members)—narrow member 20, medium or clitoral stimulation member 30, and a broad member 50—designed to facilitate varying uses. For example, the clitoral stimulation member 30 may be used to stimulate the clitoris, narrow member 20 may be used for internal and external vaginal stimulation and perineal stimulation. FIG. 4 illustrates the general anatomy of vagina 40 having a vaginal opening 40c, introitus 40a, and vaginal vault 40b. As used here vaginal opening 40c refers to the external opening (part of the vulva, not shown) of vagina 40, introitus 40a refers to the area between the external opening (vaginal opening 40) and the hymen (not shown) leading into the vaginal canal. Vaginal vault 40b refers to the expanded region of the vaginal canal enclosing the vaginal portion of the cervix (not shown). Embodiment of device 1 may be configured for both external and internal massage. In external massage all surfaces and massage tips of device 1 can be used to massage various body parts and large muscles, such as Inner thigh, adductors, lower abdomen, hips, glutes, the external genitalia (e.g., clitoris, vulva, external perineum, transverse perineal muscles, superficial pelvic floor muscles, Urogenital triangle), and others. In internal massage application preferably the narrow member may be used to massage introitus, internal perineal body, internal transverse perineal muscles, internal superficial pelvic floor muscles, rectal entrance, and others.

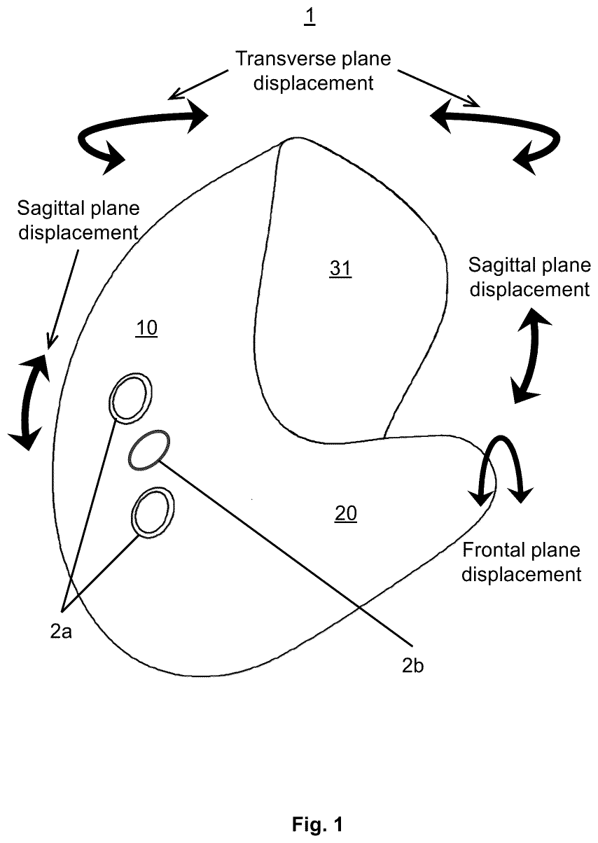

As illustrated in FIGS. 1,3, 6, massaging device 1 may comprise body 10, narrow member 20, controller 2 (e.g., a PCB), user control 2a, indicator 2b(e.g., sound, light), power source 8 (e.g., battery), power interface 9, and one or more vibrating mechanisms 6, 7.

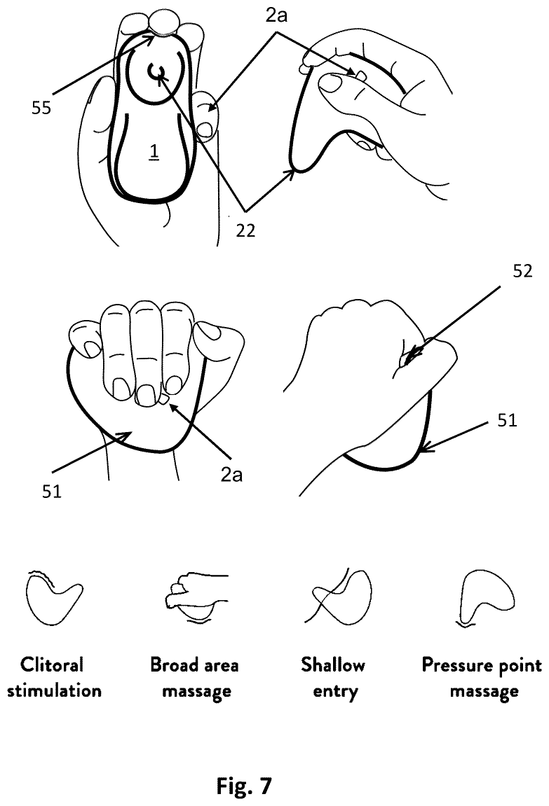

The one or more vibrating mechanisms 6, 7 may comprise a vaginal vibrating mechanism 6, a clitoral vibrating mechanism 7, or both. Vibration mechanisms (e.g., a motor) may be configured with multiple vibration patterns and varying vibration intensities. Controller 2 may enable a user to use user control 2a to control vibration mechanisms 6, 7 by turning the vibration on or off, changing the vibration pattern, and vibration intensity. Controller 2 may be configured to enable the user to control each of the one re more vibrating mechanisms 6, 7 independently or together. As illustrated in FIGS. 1 and 7, user control 2a may be positioned on device 1 so that in each orientation while using device 1 the user is able without moving the device to utilize the controller the one or more vibration mechanisms 6, 7.

Each of vibrating mechanisms 6, 7 most preferably is configured to operate at a vibration frequency from 141 Hz to 166 Hz (Hertz), and preferably from 100 Hz-250 Hz. Localized vibration at frequencies in this range appear to provide relief from pain and desensitization effects. See, e.g., Casale R, Hansson P. The analgesic effect of localized vibration: a systematic review. Part 1: the neurophysiological basis. Eur J Phys Rehabil Med. 2022 April;58 (2): 306-315. doi: 10.23736/S1973-9087.22.07415-9. Epub 2022 Feb. 1. PMID: 35102735; PMCID: PMC9980599. Embodiments of the present invention comprising both vaginal vibration mechanism 6 and clitoral vibration mechanism 7 may be configured to allow the user to select the most desirable vibration sensation (based on, e.g., pain, comfort, enjoyment) by configuring each of vibration mechanisms 6 and 7, to provide different style of vibration (e.g., “rumbly,” “buzzy”) that may be achieved by using different motor RPM, different types and sizes of motors, lighter or heavier vibration mechanism, and other methods.

The power interface 9 may be a wired electrical connector 9a (e.g., a “jack,” USB port), a wireless charging receiver 9b (e.g,. QI charging) or both. As illustrated in Flg. 6, device 1 may also comprise a casing/rigid/internal housing 3 constructed from rigid material (e.g., ABS) and outer housing/sleeve 4 that form body 10 and narrow member 20.

Casing/rigid/internal housing 3 may be constructed from rigid material (e.g., ABS). Outer housing/sleeve 4 preferably may be made from medical grade silicone or similar material.

Body 10 may comprise clitoral stimulation member/portion 30 and broad member/portion 50. clitoral stimulation surface 31 of clitoral stimulation member 30 has been designed to be applied to the clitoris as well as to the area surrounding the clitoris. Research and experimentation on anatomic variety was critical in the design process and to determine the size of the clitoral stimulation surface 31. Body 10 is configured so that the clitoral stimulation member base 32 is rigidly connected to the narrow member base forming an anatomically curved and rigid connection 3a configured to maintain the narrow member 20 and the clitoral stimulation surface 31 at a fixed relative position 60 to each other. Fixed relative position 60 enables the user to position the clitoral stimulation surface to face the clitoris whenever the narrow member tip 22 is inserted in the vagina or is touching the vaginal opening or the premium.

Narrow member 20 can be used for internal therapeutic massage and stimulation. For example, a user may begin with a shallow insertion of the narrow tip 22 as far as comfortable, preferably using lubricant, and then move the tip gently sideways (e.g., from left to right) while swooping down as the user moves the tips sideways. Massaging device 1 is shaped so that upon insertion of the narrow tip in the vagina, the clitoral stimulation surface can easily be applied to the clitoral area of the user.

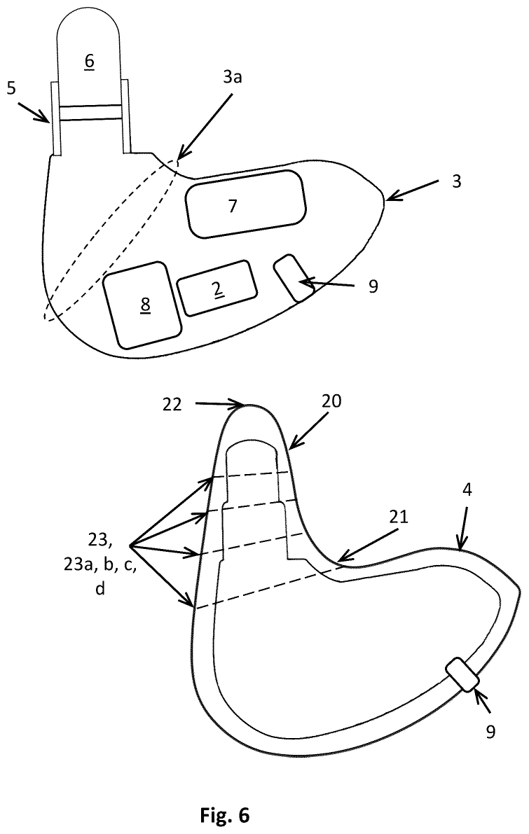

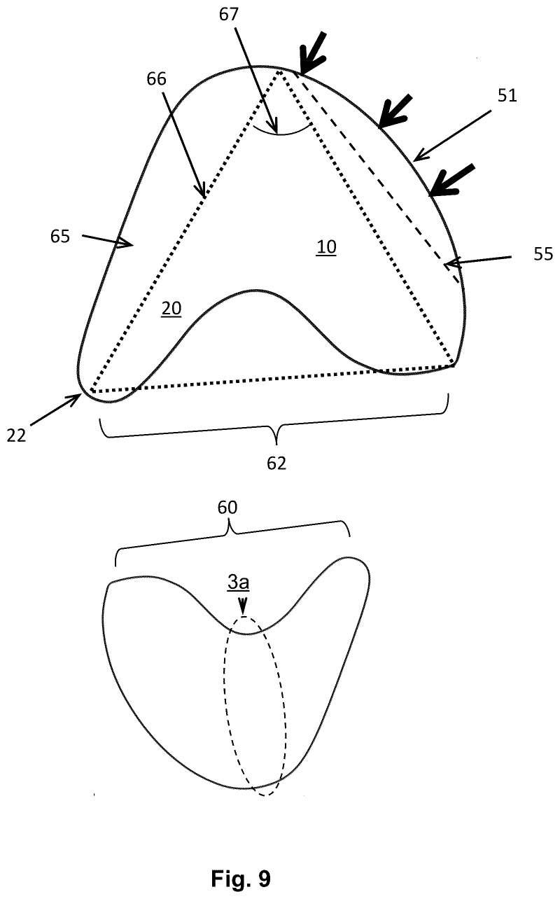

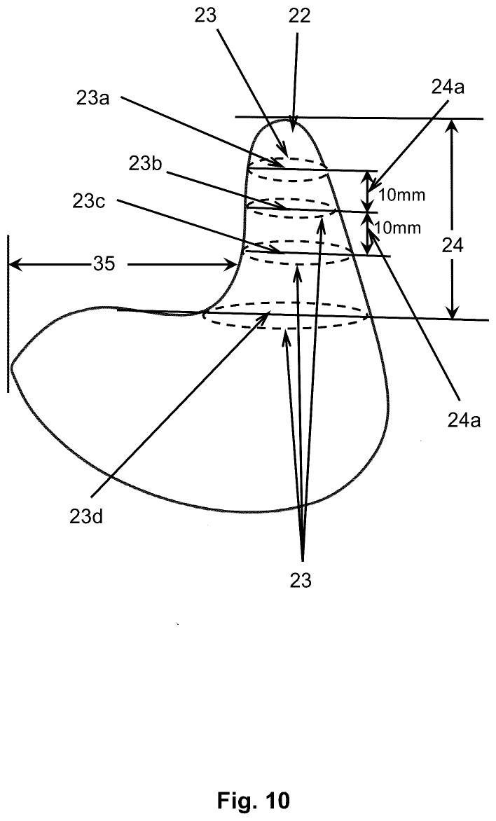

FIG. 10 illustrates narrow member 20 comprising narrow member base 21, narrow member tip/narrow tip 22, oval cross sections 23, and narrow member length 24 (i.e., the distance between the narrow tip and the clitoral stimulation surface). Narrow member (20) may also comprise vaginal vibrating mechanism 6 positioned in close proximity to, or within, narrow tip 22. FIG. 6 illustrates that vaginal vibrating mechanism 6 may be connected to casing 3 through flexible and resilient connector 5, which may act as a spring. As Illustrated in FIGS. 6, 9 the narrow member has roughly a conical shape with cross sections increasing from the tip to the base, permitting gradual insertion and causing gradual stretching of the vaginal opening as the depth of insertion increases. The narrow base cross sections are preferably oval but can be of any shape. Oval cross sections 23 have diameters 23a, 23b, 23c, and 23d that increase from the smallest diameter 23a closest to narrow tip 22 to the largest base diameter 23d corresponding to the maximum insertion of narrow member 20 in vagina 40. Gradually increasing diameters 23a, b, c, d of cross sections 23 allow for a gradual dilation of the vagina as the narrow member 20 gradually is gradually inserted in the vagina. Narrow member 20 has an oval cross section 23 and accordingly each of diameters 23abcd (also may be referred here as “thickness”) refer to the longer diameter of each oval cross section. Smallest diameter 23a, measured approximately 10 mm below the apex 22a of narrow tip 22 preferably is less than 20 mm, but may be as large as 25 mm. The base diameter 23d, which is the largest diameter of a cross section 23 of narrow member, preferably is less than approximately 40 mm, which is around the average reported penis diameter/thickness. Narrow member 20 diameters increase in size from the smallest diameter 23a to the largest base diameter 23b preferably at an average rate ranging from approximately 9 mm to 11 mm per 10 mm drop along the narrow member length 24 below diameter 23a. An average rate of increase of diameters 23abcd in the range of approximately 5 mm to 20 mm per 10 mm drop 24a along narrow member length 24 may also function according to embodiments of the present invention.

Embodiments of the present invention may be configured to only allow a shallow insertion 42 of narrow member 20 in vagina 40 as illustrated in FIGS. 4. 5 illustrates embodiments of the present invention configured to help prevent unwanted interference with the deep pelvic muscle group, for example by configuring the device so that clitoral stimulation member 30 is designed to act as a barrier and prevent a user from inserting narrow tip 22 beyond what would be considered a shallow insertion 42. Shallow insertion 42 is an insertion of the narrow member 20 into vagina 40 at a depth at which the narrow tip 22 is past the introitus 40a of the vagina but does not reach the vaginal vault 40b and the cervix (not shown). Narrow member 20 and clitoral stimulation surface 31 are at fixed position 60 relative to each other forming and angle 63 between narrow member 20 and clitoral stimulation surface 31 that ensures that when the full narrow member length 24 is inserted in vagina 40 clitoral stimulation surface 31 will press against the vagina 40 and act as a barrier preventing deeper insertion.

Different embodiments of device 1 may have different narrow member length 24 to accommodate various anatomies and narrow member length 24 may be determined by the depth of the pelvic muscles. The pelvic floor is divided into a deep and a superficial part, and preferred embodiments of massaging device 1 can focus on the superficial pelvic floor or urogenital diaphragm including the bulbocavernosus, ischiocavernosus, and transverse perineum muscles. (See, e.g., I. Harm Ernandes, et al. Assessment of the Pelvic Floor and Associated Musculoskeletal System: Guide for Medical Practitioners, Female Pelvic Medicine & Reconstructive Surgery, Vol. 27,No. 12, December 2021, pp. 711 718) available at www.augs.org/assets/1/6/assessment_of_the_pelvic_floor_and_associated_2.pdf). The superficial part can be targeted by inserting just a part of a finger, the deeper pelvic muscles can be targeted by inserting the finger deeper. The insertion is necessary to work around the vaginal opening, which helps to target specific muscles within the superficial pelvic muscle group. (Harm-Ernandes, et al). Narrow member 20 preferably is comparable in size to a finger giving the user the option to just insert narrow tip 22 (e.g., less than an inch) reaching superficial muscles.

In a preferred embodiment, narrow member length 24 is longer than introitus 40a but is shorter than the vaginal length 44 being the distance between the vaginal opening 40c and the vaginal vault 40b. According to medical research the vaginal length 44 from introitus 40a to vaginal vault 40c (or cervix, not shown) ranges from 40.8 mm to 95 mm with a mean value of 62.7 mm and a 11.25 mm standard deviation. Given these anatomical values the inventors determined that narrow member lengths 24 in the range of 25 mm to 75 mm could ensure that the narrow member 20 will only be configured for a shallow insertion for a large portion of women.

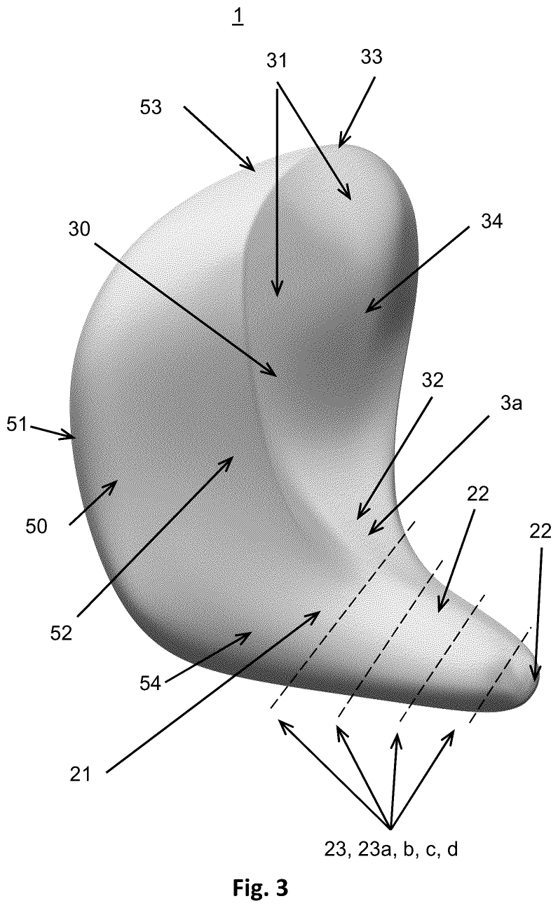

FIG. 3 illustrates clitoral stimulation member/portion 30 comprising clitoral stimulation surface 31, clitoral stimulation surface length 31a, clitoral stimulation base 32, clitoral stimulation distal edge 33, clitoral stimulation middle portion 34, clitoral stimulation member length 35, and clitoral stimulation angle 36. The clitoral stimulation surface may be substantially flat, convex, concave, wavy, textured, smooth, or of any other surface geometry and surface texture.

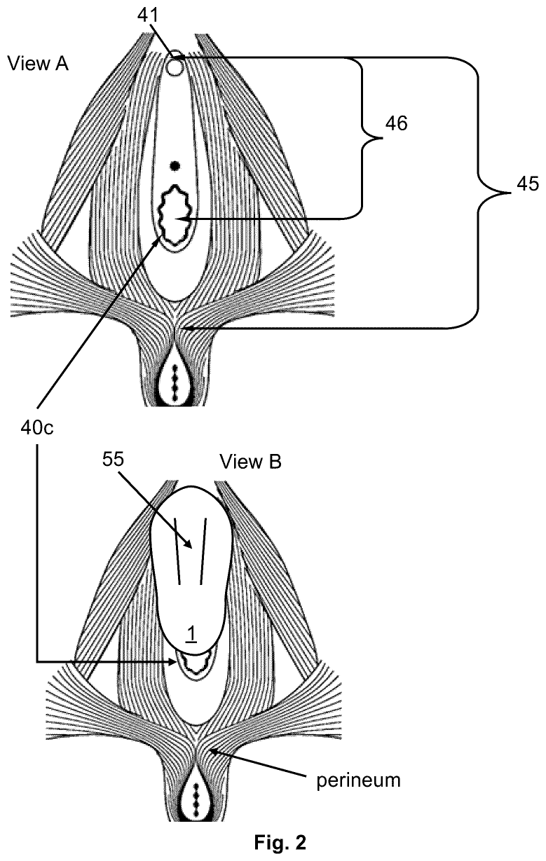

Embodiments of the present invention may also be configured so that the distance (or span) between the narrow tip and the distal edge 33 of the clitoral stimulation surface 31, as well as the clitoral stimulation surface length 35, allow for a range of different applications making such devices accessible to women with varying anatomies. FIGS. 2 and 4 illustrate the anatomy involved in the internal and external applications of device 1. Based on available anatomical statistics, Inventors determined the mean distance between the perineum and clitoris, referred here as external application span 45 (FIG. 2) to be approximately 60 mm with a standard deviation of 11.3 mm, and the mean distance between the vaginal opening and the clitoris, referred to as internal application span 46 (FIG. 2) to be approximately 35 mm with a standard deviation of 16 mm. Accordingly, clitoral stimulation surface length 31a in the range of 20 mm to 72 mm and distal edge to narrow tip span 62 (or external stimulation span 62) in the range of 20 mm to 72 mm can enable a large number of users with varying anatomies to reap the benefits of the present invention.

For example, the fixed relative position 60 between narrow member 20 and clitoral stimulation surface 31 may enable a user to stimulate the clitoris while simultaneously massaging the external vagina, vulva, or perineum, referred to as an “external massage” or “external application,” illustrated in FIG. 4 (View B), or stimulate the clitoris while the narrow member is inserted into the vagina, referred to as an “internal massage” or “internal application,” illustrated in FIG. 4 (View C) and FIG. 2 (View B).

For example, in an “internal massage” scenario, while the narrow member is inserted in the vagina embodiments of the inventions are configured to enable the user to position the clitoral stimulation surface on the clitoris and simultaneously stimulate the clitoris and the vagina. As the user's hand moves massaging device 1 to increase or decrease the penetration of the narrow tip, or alternatively without changing the penetration depth, the user changes the angle of device 1 towards or away from the user's body, the clitoral stimulation surface 31 is configured to make contact with the clitoris and apply pressure and stimulation on the clitoris. In the opposite motion, a user may increase the angle of massaging device 1 relative to the body, while maintaining the narrow penetration but decreasing the pressure and stimulation applied on the clitoris, or by moving the surface further away from the body so there is no contact with the clitoris, remove any clitoral stimulation. To accommodate wide anatomies for internal application, clitoral stimulation member length 35 preferably is in the range of 20 mm to 71 mm based on statistical information about vaginal anatomy. Kreklau A, Vâz I, Oehme F, Strub F, Brechbühl R, Christmann C, Günthert A. Measurements of a ‘normal vulva’ in women aged 15 84: a cross sectional prospective single centre study. BJOG. 2018 Dec; 125 (13): 1656 1661. doi: 10.1111/1471 0528.15387. Epub 2018 Aug. 1.PMID: 29940085.

In an example of “external massage,” while the narrow tip is in contact with the perineum (e.g., below the vaginal opening), the user is able to position the clitoral stimulation surface to stimulate the clitoris.

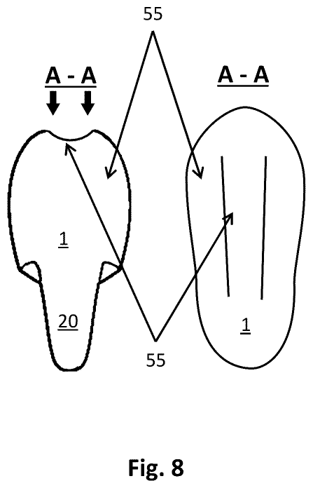

As illustrated in FIGS. 3, 8, broad member 50 may comprise broad member surface 51, broad member base 52, 1st broad member portion 53, 2nd broad member portion 54, finger groove/guide 55, and broad tip 56.

Finger guide 55, preferably in the form of a groove along broad member surface 51, may provide tactile indication to the user of finger position while the user is holding the broad member as a handrip as illustrated in FIG. 7, 8. Finger guide 55 also may facilitate the user to accurately guide and position the device and to vary the pressure the user is applying to by repositioning the user's finger along finger guide 55.

As FIG. 7 illustrates, broad member 50 may be configured as a handgrip enabling a user to hold and position massaging device 1 in various orientations and to precisely control the stimulated location and level of stimulation in each orientation. The relative position of the broad member, clitoral stimulation member, and narrow member is configured to allow a user holding the device to exercise precise and accurate control of the stimulated location and level of stimulation by displacing the device in the horizontal (transverse), sagittal, and frontal planes.

Broad member 50 can be utilized as a handgrip with a user's hand on top of the broad member surface in an insertion orientation, so that the narrow member and the clitoral stimulation member are facing the user's body. In another example, the user may utilize the broad member base as a handgrip and hold the massaging device 1 in a broad massage orientation with a broad member surface facing the user's body.

FIG. 9 illustrates the relative position 60 of broad member 50, the clitoral stimulation member 30, and narrow member 20, configured to allow a user holding massaging device 1 to exercise precise and accurate control of the stimulated location and level of stimulation. As illustrated in FIGS. 1, 3, and 7, a user may exercise such precise control by displacing the device in the horizontal (or transverse), sagittal, and frontal planes, and by turning the vibration mechanism on and off, or controlling the modality and intensity of vibration. The controller is anatomically positioned so that in each orientation, the controller positioning enables a user to control the vibration mechanism without displacing the device as illustrated in FIG. 7.

Rigid connection 3a and fixed relative position 60 of the members enable the user to perform a rocking motion in one or more planes without repositioning massaging device 1, thus massaging larger areas surrounding precise locations.

In an insertion orientation, the shape of massaging device 1 and relative positioning of the clitoral and narrow members enables a user to increase or decrease the insertion of the narrow tip or to maintain the depth of insertion while changing the entry angle without altering the position and level (e.g., contact pressure) of stimulation of the clitoris. Alternatively, the user is able to change the position of the clitoral member and/or change the level of stimulation of the clitoris without altering the depth or angle of insertion of the narrow member in the vaginal opening. The handgrip and relative position of the clitoral stimulation member and the narrow member also enable the user to maintain the level of interaction (i.e., pressure) between the clitoral surface (or clitoral tip) and the clitoris while adjusting the depth and/or angle of insertion of the narrow tip.

As illustrated in FIG. 9, body 10 and narrow member 20 form an ergonomic triangular shape, or simply a triangle 66, formed by the external stimulation span (62), the broad member surface, and narrow tip broad tip span (triangle side) (65). By utilizing the body as a handgrip and applying pressure along the broad member surface 51, which is a side of ergonomic triangle 66 the user is able to apply accurate pressure on the body through the narrow member. Broad member surface may be curved to fit in a palm enabling the user to securely hold device 1 and to apply pressure on broad member surface 51 without much twisting or bending of the wrist. In ergonomic triangle 66, broad member surface 51 and narrow member 20 form a pressure transfer angle 67 configured to transfer the pressure a user may apply on broad member surface 51 to narrow tip 22 through the narrow member 20. Pressure transfer angle 67 preferably is less than 90 degrees, but embodiments may be implemented with angle 67 being 90 degrees or larger.

The ergonomic design of various embodiments of device 1 may help users with dexterity issues. The triangular shape, triangle 66, can facilitate a comfortable and secure grip, enabling ambidextrous use without requiring complex wrist movements or awkward reaching. Embodiment with finger guide 55 can promote a power grip, allowing users to apply pressure effectively while maintaining a neutral wrist position, which may be beneficial for users with conditions like arthritis. Ergonomically designed embodiments may also enable users to use different varying grips depending on users' abilities and preferences. Body 10 comprising power source 8, controller 2, clitoral vibration mechanism 7, and other components may be larger and heavier than narrow member 20 enabling a user to use Body 10 as a power handgrip that may provide additional control, facilitate the application of pressure, stabilize device 1, and distribute the applied pressure.

While the invention has been described with reference to exemplary embodiments, it will be understood by those skilled in the art that various changes, omissions, and/or additions may be made and equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiments disclosed as the best mode contemplated for carrying out this invention, but that the invention will include all embodiments falling within the scope of the appended claims. Moreover, unless specifically stated any use of the terms first, second, additional, etc. do not denote any order or importance, but rather the terms first, second, additional, etc. are used to distinguish one element from another.

1. An anatomically based, ergonomic, multipurpose massaging device comprising:
a controller comprising a user control;
a vaginal vibrating mechanism;
a clitoral vibrating mechanism;
a body comprising:
a broad member; and,
a clitoral stimulation surface;
a narrow member comprising:
a narrow member base; and,
a narrow member tip; and,
a narrow member length;
wherein the body and the narrow member are connected to each other in a fixed relative position to each other;
wherein the clitoral stimulation surface forms a clitoral stimulation angle with the narrow member;
wherein the vaginal vibrating mechanism is positioned proximate to the narrow tip;
wherein the clitoral vibrating mechanism is positioned proximate to the clitoral stimulation surface;
wherein the controller is configured to enable a user to utilize the user control to turn on one or more of the vaginal vibrating mechanism and the clitoral vibrating mechanism;
wherein the narrow member is configured to allow a shallow insertion in a vagina having a vaginal opening, an introitus, and a vaginal vault;
wherein the shallow insertion is an insertion of the narrow tip past the introitus without reaching the vaginal vault;
wherein the narrow member length is longer than the introitus and is shorter than the distance between the vaginal opening and the vaginal vault;
wherein the fixed relative position is configured to enable the clitoral stimulation surface to rest against the vagina and to prevent the user from inserting the narrow member tip deeper than the narrow member length;
wherein the device is configured to enable the user to simultaneously stimulate the clitoris and to insert the narrow member in the vagina;
wherein the fixed relative position enables the user to position the clitoral stimulation surface on the clitoris while inserting the narrow member in the vagina; and, wherein the clitoral stimulation surface has a clitoral stimulation surface length longer than the distance between the vagina and the clitoris.

2. The device of claim 1, wherein the device is further configured to enable the user to simultaneously stimulate the clitoris and the external perineum;
wherein the fixed relative position enables the user to position the clitoral stimulation surface on the clitoris while the narrow tip is positioned on the perineum;
wherein an external stimulation span between a distal edge of the clitoral stimulation surface and the narrow tip is longer than the distance between the perineum and the clitoris; and, wherein the distal edge connects the clitoral surface and a broad member surface farthest from the narrow member base.

3. The device of claim 2, wherein the narrow member comprises oval cross sections with diameters that increase from the narrow tip to the narrow member base to enable the user to gradually dilate the vagina by inserting the narrow member in the vagina.

4. The device of claim 3, wherein the broad member comprises a finger groove configured to:
provide tactile indication to the user of finger positions;
allow the user to guide the device in a plurality of orientations by placing a finger in the groove; and,
enable the user to apply varied pressure on the narrow tip and clitoral stimulation surface by repositioning the finger in the groove.

5. The device of claim 4, wherein the body and the narrow member form an ergonomic triangle by the external stimulation span, the broad member surface, and a narrow tip broad tip span;
wherein the device is configured to enable the user to ergonomically apply pressure with the narrow member by utilizing the body as a handgrip;
wherein the broad member surface is curved to fit in a palm enabling the user to securely hold the device and to apply pressure on the broad member surface without wrist bending; and,
wherein the broad member surface and the narrow member form a pressure transfer angle configured to transfer the pressure applied on the broad member surface through the narrow member to the narrow tip.

6. The device of claim 5 further comprising a casing;
wherein the casing comprises:
the vaginal vibrating mechanism;
the clitoral vibrating mechanism; and,
a power source being one or both of a battery and power interface;
wherein the casing rigidly connects the body and the narrow member base and maintains the body and the narrow member base at a fixed relative position; and,
wherein the power interface is selected from a wired electrical connector and a wireless charging receiver.

7. The device of claim 6, wherein the vaginal vibrating mechanism and clitoral vibrating mechanism are configured to vibrate at frequencies ranging from 100 Hz to 250 Hz.

8. The device of claim 7, wherein the diameters increase from the narrow tip to the narrow member base at a rate ranging from 7.5 mm to 15 mm of diameter increase for 10 mm drop along the narrow member length;
wherein the diameters comprise a base diameter no larger than 40 mm;
wherein the narrow member length is in the range of 25 mm to 75 mm;
wherein the external stimulation span is in the range from approximately 30 mm to 90 mm; and,
wherein the clitoral stimulation surface length is no less than 20 mm and no greater than 72 mm.

9. The device of claim 8, wherein the narrow member length is in the range from approximately 45 mm to 55 mm.

10. The device of claim 6 further comprising a first outer housing;
wherein the casing is positioned inside the first outer housing; and, wherein the first outer housing and the casing form the narrow member and the body.

11. The device of claim 10 further comprising a second outer housing;
wherein the casing and the first outer housing are configured to enable the casing to be removably positioned in the first outer housing;
wherein the casing and the second outer housing are configured to enable the casing to be removably positioned in the second outer housing;
wherein the first outer housing and the casing form a first narrow member having a first narrow member length;
wherein the second outer housing and the casing form a second narrow member having a second narrow member length; and,
wherein the first narrow member length is different from the second narrow member length.
